(19) United States
(12) Patent Application Publication
(10) Pub. No.: US 2026/0327142 A1
(43) Pub. Date: Oct. 22, 2026

(54) ALUMINA-ZIRCONIA-SILICA REFRACTORY PRODUCT

(71) Applicant: SAINT-GOBAIN CENTRE DE RECHERCHES ET D'ETUDES EUROPEEN, COURBEVOIE (FR)

(72) Inventors: Isabelle CABODI, CAVAILLON (FR); Olivier CITTI, CAVAILLON (FR); Isabell GROSS, CAVAILLON (FR); Pierrick VESPA, CAVAILLON (FR); Michel GAUBIL, CAVAILLON (FR)

(21) Appl. No.: 19/120,386

(22) PCT Filed: Oct. 13, 2023
(86) PCT No.: PCT/EP2023/078573

§ 371 Date: Apr. 11, 2025

(30) Foreign Application Priority Data
Oct. 14, 2022 (FR) FR2210621

(51) Int. Cl. C04B 35/484; F27B 14/08; G01N 22/00

(52) U.S. Cl. CPC C04B 35/484; F27B 14/08; G01N 22/00; C04B 2235/3201; C04B 2235/3217; C04B 2235/3244; C04B 2235/3409; C04B 2235/3418; C04B 2235/9669

(57) ABSTRACT

A molten cast refractory product includes, in mass percent on the basis of oxides, and for a total of 100%:
ZrO₂+HfO₂: 39.0% to 55.0% with HfO₂<5%,
SiO₂: 10.5% to 14.0%,
Al₂O₃: complement to 100%,
Na₂O+K₂O: 0.80% to 3.00%,
B₂O₃: <1.0%,
Fe₂O₃+TiO₂: <0.60%,
other types: <1.0%
   where the ratio (K₂O/1.52)/(Na₂O+K₂O/1.52) is greater than 0.30 with Na₂O<0.60%, or—the ratio (K₂O/1.52)/(Na₂O+K₂O/1.52) is greater than 0.60.

### TECHNICAL FIELD

The invention relates to an AZS (alumina-zirconia-silica) fused refractory product and also to a glass melting furnace including such a product.

### PRIOR ART

Glass melting furnaces generally comprise a very large number of refractory products, arranged in different places according to their properties. For each part of the furnace, the product chosen will be the one that does not cause any defects that render the glass unusable (which would reduce production yields) and that is resistant long enough to afford the furnace a satisfactory service life.

Among refractory blocks, a distinction is made between fused blocks and sintered blocks.

Unlike sintered blocks, fused blocks usually include an intergranular vitreous phase connecting crystalline grains. The problems encountered with sintered blocks and fused blocks, and the technical solutions adopted for solving them, are thus generally different. A composition developed for manufacturing a sintered block thus cannot in principle be used as such for manufacturing a fused block, and vice versa.

Fused blocks, often referred to as “electrofused blocks” or “fused cast blocks”, are obtained by melting a mixture of suitable starting materials in an electric arc furnace or via any other suitable technique. The molten material is then conventionally cast in a mold, and then solidified. Generally, the product obtained then undergoes a controlled cooling cycle to be brought to ambient temperature without fracturing. This operation is known to those skilled in the art as “annealing”.

Alumina-zirconia-silica (AZS) fused products are known, predominantly including alumina (Al₂O₃), zirconia (ZrO₂) and silica (SiO₂). In particular, AZS products conventionally include less than 80% by mass of zirconia. AZS products also contain corundum (free or in the form of a corundum/zirconia eutectic) in an amount generally greater than 10%, or even greater than 30%.

AZS products conventionally include sodium oxide Na₂O to give the vitreous phase suitable physical and chemical properties. Generally, K₂O and Na₂O are considered to have equivalent effects.

U.S. Pat. No. 2,438,552 recommends the addition of sodium oxide (1.0% to 2.2%) and a total MgO+CaO content of between 0.2% and 0.8%, in response to feasibility problems relating to AZS products including 9% to 12% SiO₂ and 0.4% to 1.7% iron oxide.

EP 939 065 proposes to reduce the degree of exudation of AZS products containing 20% to 59% ZrO₂ and 5% to 12% SiO₂ by adding B₂O₃, P₂O₅ and at least one of the oxides of the group SnO₂, ZnO, CuO and MnO₂.

WO 2011/161 588 proposes exudation-resistant AZS products containing, in addition to Al₂O₃, 30% to 50% ZrO₂, 8% to 16% SiO₂, Y₂O₃ and more than 0.2% Na₂O+K₂O+B₂O₃.

One of the factors limiting the life of glass furnaces is wear on the blocks, in particular the blocks constituting the side walls of the vessel. Monitoring the residual thickness of fused blocks in a furnace in use is difficult, notably due to the temperature of their environment. Methods for monitoring blocks have been developed. In particular, methods are known using electromagnetic waves, in particular radar waves (“Radar based sensors” (TOF)). However, the applications of these methods are limited to cases in which the residual thickness is small.

There is thus an ongoing need to improve these methods.

### DISCLOSURE OF THE INVENTION

### Summary of the Invention

The invention proposes a fused cast refractory product including, as mass percentages on an oxide basis and for a total of 100%:

| ZrO₂ + HfO₂: | 39.0% to 55.0%, with HfO₂ <5% |
|---|---|
| SiO₂: | 10.5% to 14.0% |
| Al₂O₃: | remainder to 100% |
| Na₂O + K₂O: | 0.80% to 3.00% |
| B₂O₃: | <1.0% |
| Fe₂O₃ + TiO₂: | <0.60% |
| other species: | <1.0% |

the ratio (K₂O/1.52)/(Na₂O+K₂O/1.52) being greater than 0.30 with Na₂O<0.60%, or
the ratio (K₂O/1.52)/(Na₂O+K₂O/1.52) being greater than 0.60%.

As will be seen in greater detail later in the description, rather than seeking to improve the equipment used for the monitoring, the inventors sought to improve the quality of the response of the blocks subjected to such monitoring. They discovered, surprisingly, that Na₂O and K₂O had a different effect on the ability of radar waves to penetrate a block made of a product according to the invention. In addition, they discovered that, in a content range determined by several criteria, and in particular by the ratio (K₂O/1.52)/(Na₂O+K₂O/1.52), Na₂O and K₂O not only improve the penetration capacity of radar waves into the block, but also preserve the feasibility.

Monitoring may thus be performed to a greater depth, preferably over the entire thickness of the block.

A product according to the invention is thus perfectly suitable for monitoring of its residual thickness.

A product according to the invention may also include one or more of the following optional features, including when it complies with the particular embodiments described hereinbelow and when these optional features are not incompatible with said particular embodiments:
the total porosity of the product is less than 10%, or even less than 5%;
preferably, the oxides represent more than 90%, more than 95%, more than 99% or even substantially 100% of the mass of the product;
the mass content of ZrO₂+HfO₂ is less than 54.0%, or even less than 53.0%, or even less than 52.5%, or even less than 52.0%, or even less than 51.0%, or even less than 50.5%, or even less than 50.0%, or even less than 49.5%, or even less than 49.0%, or even less than 48.5%, or even less than 48.0%, or even less than 47.0%, or even less than 46.0%, and/or more than 40.0%, or even more than 41.0%, or even more than 42.0%, or even more than 42.5%, or even more than 43.0%, or even more than 43.5%, or even more than 44.0%, or even more than 44.5%, or even more than 45.0%, or even more than 45.5%;
the SiO₂ mass content is less than 13.8%, or even less than 13.6%, or even less than 13.5%, or even less than 13.4%, or even less than 13.3%, or even less than 13.2%, or even less than 13.0%, or even less than 12.7%, or even less than 12.5% and/or preferably more than 10.6%, or even more than 10.7%, or even more than 10.8%, or even more than 10.9%, or even more than 11.0%, or even more than 11.3%, or even more than 11.5%;
the Al₂O₃ mass content is less than 46.0%, or even less than 45.5%, or even less than 45.0%, or even less than 44.0%, or even less than 43.5%, or even less than 43.0%, or even less than 42.0% and/or more than 29.0%, or even more than 30.0%, or even more than 32.0%, or even more than 34.0%, or even more than 36.0%;
the sum of the mass contents of sodium oxide Na₂O and potassium oxide K₂O is preferably greater than 0.85%, greater than 0.90%, greater than 0.95%, greater than 1.00% and/or preferably less than 2.90%, preferably less than 2.80%, preferably less than 2.70%, preferably less than 2.60%, less than 2.50%, even less than 2.30%, even less than 2.20%, even less than 2.10%, even less than 2.00%, even less than 1.90%;
the Na₂O mass content is preferably less than 1.50%, or even less than 1.40%, or even less than 1.30%, or even less than 1.20%, or even less than 1.00%, or even less than 0.80%, or even less than 0.75%, or even less than 0.60%, or even less than 0.55%, or even less than 0.50%, or even less than 0.40%, less than 0.30%, less than 0.20%, or less than 0.10%; in one embodiment, Na₂O is present as an impurity;
the K₂O mass content is preferably less than 2.50%, or even less than 2.00%, or even less than 1.90%, or even less than 1.80%, or even less than 1.70%, or even less than 1.60%, or even less than 1.50%, and/or greater than 0.60%, greater than 0.65%, or even greater than 0.70%, or even greater than 0.75%, or even greater than 0.80%, or even greater than 1.00%;
the ratio (K₂O/1.52)/(Na₂O+K₂O/1.52) is greater than 0.40, or even greater than 0.45, or even greater than 0.50, or even greater than 0.60, or even greater than 0.62, or even greater than 0.65, or even greater than 0.70, or even greater than 0.75, or even greater than 0.80 and/or less than 0.95, or even less than 0.90;
B₂O₃ is present as an impurity and/or the mass content of boron oxide B₂O₃ is less than 0.90%, preferably less than 0.80%, preferably less than 0.70%, preferably less than 0.60%, preferably less than 0.50%, less than 0.40%, or even less than 0.30%, or even less than 0.20%, or even less than 0.10%;
the Y₂O₃ mass content is less than 0.80%, or even less than 0.60%, or even less than 0.50%, or even less than 0.40%, or even less than 0.30%, or even less than 0.20%;
the sum of the mass contents of iron oxide and titanium oxide, Fe₂O₃+TiO₂, is less than 0.40%, preferably less than 0.30%, more preferably less than 0.20%;
the total mass content of the “other species” is less than 0.9%, or even less than 0.8%, or even less than 0.6%, or even less than 0.5%, or even less than 0.4%;
the “other species”, i.e. other than ZrO₂, HfO₂, SiO₂, Al₂O₃, Na₂O, K₂O, B₂O₃, Fe₂O₃ and TiO₂, consist only of impurities;
the mass content of any “other species”, notably Ta₂O₅ and/or Nb₂O₅, is less than 0.4%, or even less than 0.3%, or even less than 0.2%, or less than 0.1%;
the sum of the mass contents of calcium oxide CaO, barium oxide BaO, strontium oxide SrO and magnesium oxide MgO is less than 0.6%, less than 0.5%, less than 0.4% or even less than 0.3%;
the CaO mass content is less than 0.4% or even less than 0.3%;
the BaO mass content is less than 0.4% or even less than 0.3%;
the SrO mass content is less than 0.4% or even less than 0.3%;
the MgO mass content is less than 0.4% or even less than 0.3%;
the product is in the form of a block.

According to a particularly advantageous embodiment, the fused cast refractory product according to the invention comprises, as mass percentages based on the oxides:

| ZrO₂ + HfO₂: | 39.0% to 51.0%, preferably 39.0% to |
|---|---|
| | 49.5%, preferably 42.5% to 49.5%, |
| SiO₂: | 10.5% to 14.0% |
| Al₂O₃: | remainder to 100% |
| Na₂O + K₂O: | 0.80% to 2.50%, or even 0.80% to 2.00% |
| Na₂O: | <0.60% |
| K₂O: | <2.00% |
| B₂O₃: | <1.0%, or even <0.5% |
| Fe₂O₃ + TiO₂: | <0.60% |
| other species: | <1.0% |

with a ratio (K₂O/1.52)/(Na₂O+K₂O/1.52) greater than 0.60, or even greater than 0.65.

According to a particularly advantageous embodiment, the fused cast refractory product according to the invention comprises, as mass percentages based on the oxides:

| ZrO₂ + HfO₂: | 39.0% to 51.0%, preferably 39.0% to |
|---|---|
| | 49.5%, preferably 42.5% to 49.5%, |
| SiO₂: | 10.5% to 13.0% |
| Al₂O₃: | remainder to 100%, preferably <44.0% |
| K₂O: | 1.00% to 2.00%, preferably 1.10% to 1.80% |
| Na₂O: | <0.50%, preferably <0.40%, preferably <0.30% |
| B₂O₃: | <1.0% |
| Fe₂O₃ + TiO₂: | <0.60% |
| other species: | <1.0% |

with a ratio (K₂O/1.52)/(Na₂O+K₂O/1.52) greater than 0.65, or even greater than 0.70.

According to a particularly advantageous embodiment, the fused cast refractory product according to the invention comprises, as mass percentages based on the oxides:

| ZrO₂ + HfO₂: | 42.5% to 49.5%, preferably 42.5% to 48.0% |
|---|---|
| SiO₂: | 10.5% to 13.0%, preferably 11.0% to 13.0% |
| Al₂O₃: | remainder to 100% |
| K₂O: | 0.70% to 1.80%, preferably 0.80% to 1.60% |
| Na₂O: | <0.60%, preferably <0.50%, preferably <0.40% |
| B₂O₃: | <1.0% |
| Fe₂O₃ + TiO₂: | <0.60% |
| other species: | <1.0% |

with a ratio (K₂O/1.52)/(Na₂O+K₂O/1.52) greater than 0.62, preferably greater than 0.65, preferably greater than 0.70.

According to a particular embodiment, the fused cast refractory product according to the invention comprises, as mass percentages based on the oxides:

| | |
|---|---|
| ZrO₂ + HfO₂: | 39.0% to 49.5%, or even 42.5% to 49.5% |
| SiO₂: | 10.5% to 14.0%, or even 10.5% to 13.0% |
| Al₂O₃: | remainder to 100%, preferably <44.0% |
| Na₂O + K₂O: | 1.00% to 2.50% |
| Na₂O: | <0.50%, or even <0.30% |
| K₂O: | <2.00%, or even 0.60% to 1.80% |
| B₂O₃: | <1.0%, or even <0.5% |

with a ratio (K₂O/1.52)/(Na₂O+K₂O/1.52) greater than 0.60, or even greater than 0.65.

According to a particular embodiment, the fused cast refractory product according to the invention comprises, as mass percentages based on the oxides:

| ZrO₂ + HfO₂: | 42.5% to 49.5% |
|---|---|
| SiO₂: | 10.5% to 13.0% |
| Al₂O₃: | remainder to 100%, preferably <44.0% |
| Na₂O + K₂O: | 1.00% to 2.00% |
| Na₂O: | <0.60% |
| K₂O: | <2.00% |
| B₂O₃: | <0.5% |

with a ratio (K₂O/1.52)/(Na₂O+K₂O/1.52) greater than 0.50.

According to a particular embodiment, the fused cast refractory product according to the invention comprises, as mass percentages based on the oxides:

| ZrO₂ + HfO₂: | 42.5% to 49.5% |
|---|---|
| SiO₂: | 10.5% to 13.0% |
| Al₂O₃: | remainder to 100%, preferably <44.0% |
| Na₂O + K₂O: | 1.00% to 2.00% |
| Na₂O: | <1.00% |
| K₂O: | <2.00% |
| B₂O₃: | <0.5% |

with a ratio (K₂O/1.52)/(Na₂O+K₂O/1.52) greater than 0.60.

According to a particular embodiment, the fused cast refractory product according to the invention comprises, as mass percentages based on the oxides:

| | |
|---|---|
| Al₂O₃: | <44.0% |
| ZrO₂ + HfO₂: | 42.5% to 49.5%, or even 43.5% to 48.0% |
| SiO₂: | 10.5% to 14.0%, preferably 10.5% to 13.5% |
| Na₂O + K₂O: | 1.00% to 2.00% |
| Na₂O: | <0.60% |
| K₂O: | <2.00%, preferably 0.30 to 1.80% |

with a ratio (K₂O/1.52)/(Na₂O+K₂O/1.52) preferably greater than 0.60, preferably greater than 0.62, or even greater than 0.65, 0.70 or 0.75.

In a particular embodiment, the fused cast refractory product according to the invention comprises, as mass percentages based on the oxides:

| ZrO₂: | 45.5% to 48.0% |
|---|---|
| SiO₂: | 10.5% to 13.0% |
| Na₂O + K₂O: | 1.00% to 2.00% |
| Na₂O: | <0.60% |
| K₂O: | <2.00% |

with a ratio (K₂O/1.52)/(Na₂O+K₂O/1.52) greater than 0.65.

To the extent that the above optional features are not technically incompatible with each other, they may be combined.

The invention also relates to a process for manufacturing a refractory product according to the invention, comprising the following successive steps:
a) mixing starting materials so as to form a feedstock,
b) melting said feedstock until a molten material is obtained,
c) casting and solidifying said molten material, by cooling, so as to obtain a refractory product, this process being noteworthy in that said starting materials are chosen in such a manner that said refractory product is in accordance with the invention.

Preferably, the oxides for which a minimum content is required, or precursors of these oxides, are added systematically and methodically. Preferably, account is taken of the contents of these oxides in the sources of the other oxides in which they are present as impurities.

Preferably, cooling is controlled, preferably so as to be performed at a rate of less than 20° C. per hour, preferably at a rate of about 10° C. per hour.

The invention also relates to a glass melting furnace including a refractory product according to the invention, or a refractory product manufactured or capable of having been manufactured according to a process according to the invention, in particular in a region intended to be in contact with molten glass, in particular in a glass melting furnace vessel, in particular to constitute an electrode holder block, for example in a hearth of such a vessel.

The invention thus relates to a glass melting furnace including a vessel intended to contain or containing molten glass, the vessel including a block made of a product according to the invention.

Finally, the invention relates to a process for monitoring a glass melting furnace according to the invention, said process including the following operations:
application of an electromagnetic wave to a block of a refractory product according to the invention, preferably a radar-type wave, with a frequency preferably between 1 and 10 gigahertz, or even between 1 and 6 gigahertz;
analysis of the signal received in response to said application so as to determine information relating to said block or to a change of medium, notably reflecting an interface between the block and the medium.

In one embodiment, the application of the electromagnetic wave is performed while the furnace is in operation, the block optionally being in contact with molten glass.

The application of the electromagnetic wave and the analysis may be performed via any known technique, for example using the SmartMelter® device proposed by PaneraTech.

### Definitions

Conventionally, a product is said to be “molten” when it is obtained via a process in which a feedstock is melted until a molten material is obtained, and this material is then solidified by cooling.

A block is an object whose dimensions are all greater than 10 mm. All the dimensions of a block according to the invention are preferably greater than 50 mm, preferably greater than 100 mm. A block according to the invention may, for example, have a general parallelepiped shape or a specific shape suitable for its use. Unlike a layer, a block made of a fused cast refractory product is conventionally obtained via a process including molding and demolding operations.

The block of a product according to the invention, before or after cropping/machining, may have one, or even two or three overall dimensions (thickness, length or width) of at least 150 mm, preferably at least 250 mm, or even at least 400 mm, or even at least 500 mm, or even at least 600 mm, or even at least 800 mm or even at least 1000 mm, and/or less than 2000 mm.

Unless otherwise mentioned, all the oxide contents in a product according to the invention are mass percentages based on the oxides. A mass content of an oxide of a metallic element refers to the total content of this element expressed in the form of the most stable oxide, in accordance with the standard industry convention.

HfO₂ is not chemically dissociable from ZrO₂. However, according to the present invention, HfO₂ is not deliberately added to the feedstock. HfO₂ therefore denotes only traces of hafnium oxide, this oxide always being naturally present in sources of zirconium oxide in contents generally less than 5%, more generally less than 2%. In a block according to the invention, the HfO₂ mass content is less than 5%, preferably less than 3%, more preferably less than 2%. For the sake of clarity, the total content of zirconium oxide and traces of hafnium oxide may be denoted either by “ZrO₂” or by “ZrO₂+HfO₂”. HfO₂ is thus not included in the “other species”.

The term “impurities” refers to the unavoidable constituents introduced with the starting materials or resulting from reactions with these constituents. The impurities are not necessary constituents, but merely tolerated constituents. For example, the compounds that make up the group of oxides, nitrides, oxynitrides, carbides, oxycarbides, carbonitrides and metallic species of iron, titanium, vanadium and chromium are impurities.

The total porosity, as a percentage, is conventionally equal to 100×(1−the ratio of the geometric density divided by the absolute density).

The geometric density is measured according to the standard ISO 5016:1997 or EN 1094-4 and expressed in g/cm³. It is conventionally equal to the ratio of the mass of the sample divided by the bulk volume.

The absolute density value, expressed in g/cm³, may be measured by dividing the mass of a sample by the volume of this sample ground so as to substantially remove the porosity.

### DETAILED DESCRIPTION

In the fused cast products according to the invention, the ZrO₂+HfO₂ content allows high corrosion resistance requirements to be met. On the other hand, excessively high contents are detrimental to the industrial feasibility of blocks.

Hafnium oxide, HfO₂, present in the product according to the invention, is preferably the hafnium oxide naturally present in ZrO₂ sources. Its content in a product according to the invention is thus less than 4%, generally less than 2%, or even less than 1%.

The presence of SiO₂ notably allows the formation of an intergranular vitreous phase which contributes to the feasibility of the products because it is capable of efficiently accommodating temperature deformations. The SiO₂ mass content is preferably limited so as to limit the amount of vitreous phase.

The presence of Na₂O+K₂O contributes to the feasibility of the products. The mass content of Na₂O+K₂O is preferably limited so as to limit the amount of vitreous phase and notably to maintain good resistance to corrosion by molten glass and also good wave propagation.

The presence of K₂O is necessary in order to have a ratio (K₂O/1.52)/(Na₂O+K₂O/1.52) greater than 0.30, or even greater than 0.40, or even greater than 0.50, or even greater than 0.60, or even greater than 0.62, or even greater than 0.65, and to allow good penetration of the waves into the block.

Na₂O has an adverse effect on the good penetration of waves into the block. The mass content of sodium oxide Na₂O must therefore remain limited.

B₂O₃ may have an adverse effect on the feasibility. The mass content of boron oxide B₂O₃ must therefore remain limited.

Y₂O₃ may have an adverse effect on the feasibility. The mass content of Y₂O₃ must therefore remain limited.

According to the invention, the mass content of Fe₂O₃+TiO₂ is less than 0.60%, preferably less than 0.50%, more preferably less than 0.30%. Preferably, the P₂O₅ mass content is less than 0.05%. Specifically, these oxides are harmful, notably for the exudation of refractory products or the coloring of glass, and their content must be limited to traces introduced as impurities with the starting materials.

The “other species” are the oxide species not listed above, namely species other than ZrO₂, HfO₂, SiO₂, Al₂O₃, Na₂O, K₂O, B₂O₃, Y₂O₃, TiO₂ and Fe₂O₃. In one embodiment, the “other species” are limited to species whose presence is not particularly desired and which are generally present as impurities in the starting materials.

Preferably, the product according to the invention is in the form of a block, preferably a block of which at least one, preferably at least two, or even all of the overall dimensions are greater than 150 mm.

The total porosity of the product according to the invention is less than 15%, or even less than 10%, or even less than 5%, or even less than 2%, or even less than 1%.

A product according to the invention may conventionally be manufactured according to steps a) to c) described below:
a) mixing starting materials so as to form a feedstock,
b) melting said feedstock until a molten material is obtained,
c) solidifying said molten material, by cooling, so as to obtain a refractory product according to the invention.

In step a), the starting materials are chosen so as to ensure the oxide contents in the finished product obtained on conclusion of step c). A person skilled in the art knows perfectly well how to choose the starting materials to this end.

In step b), melting is preferably performed by virtue of the combined action of a fairly long electric arc, which does not produce any reduction, and stirring to promote reoxidation of the products.

It is preferable to perform the melting under oxidizing conditions for the targeted applications.

Preferentially, the long arc melting process described in French patent No. 1 208 577 and its additions No. 75893 and No. 82310 is used.

Said process consists in using an electric arc furnace, the arc of which shoots up between the feedstock and at least one electrode spaced apart from said feedstock, and in adjusting the length of the arc so that its reducing action is reduced to a minimum, while maintaining an oxidizing atmosphere above the molten bath and stirring said bath, for example by the action of the arc itself.

In step c), cooling is preferably performed at a rate of less than 20° C. per hour, preferably at a rate of about 10° C. per hour, preferably in a mold of the desired dimensions, taking into account the feeding and possible machining after step c).

Any conventional process for manufacturing molten zirconia-based products intended for applications in glass melting furnaces can be used, provided that the composition of the starting feedstock makes it possible to obtain products having a composition in accordance with that of a product according to the invention.

### EXAMPLES

The following nonlimiting examples are given for the purpose of illustrating the invention.

In these examples, the following starting materials were used:
zirconia Q1 containing on average 99% ZrO₂+HfO₂,
“Sable BE01 Bédouin” silica containing on average 99% SiO₂,
AC34 alumina containing on average 99% Al₂O₃,
sodium carbonate containing on average 99.5% Na₂CO₃ as a source of Na₂O,
potassium carbonate containing on average 99.5% K₂CO₃ as a source of K₂O.

The products were prepared via the conventional arc furnace melting process, and then cast in a mold to obtain blocks with a minimum size of 150 mm×250 mm×500 mm after cropping.

### Chemical Analysis

The average chemical analysis of the products obtained is given in table 1; this is a chemical analysis of the liquid feedstock poured into the mold, given in mass percentages.

The species other than ZrO₂, HfO₂, SiO₂, Al₂O₃, B₂O₃, Na₂O and K₂O, in particular Fe₂O₃, TiO₂ and Y₂O₃ (possibly present) are impurities, with Y₂O₃<0.2% and Fe₂O₃+TiO₂<0.3%.

In Table 1, the HfO₂ content is always less than 4%. The ratio (K₂O/1.52)/(Na₂O+K₂O/1.52) is referred to as the “Ratio”.

### Feasibility

The outer state of the products obtained was observed. Their size, with the three dimensions greater than 150 mm and at least one dimension of at least 400 mm, enables estimation of the industrial feasibility. If there is a through slit, the feasibility is judged to be unsatisfactory. The products are then cut in half to observe the filling. In the event of incorrect filling, the feasibility is deemed unsatisfactory. Otherwise, the feasibility is deemed satisfactory. All the examples in the invention have a satisfactory feasibility.

### Wave Propagation Measurement

On the various examples of blocks produced, cylindrical bars of product about 4 mm in diameter and 13 mm high were penetrated by a 2.4 gigahertz wave at 1000° C. (corresponding to a temperature close to that of the external face of the vessel blocks). The signal received is studied to evaluate the depth at which the wave lost half its power (half-power depth: HPD); this is then divided by the value obtained for the reference (Example 1*) and multiplied by 100 to give an index P of wave propagation.

TABLE 1

| | ZrO₂ + | SiO₂ | Al₂O₃ | Na₂O | K₂O | B₂O₃ | Na₂O + | | |
|---|---|---|---|---|---|---|---|---|---|
| | HfO₂ (%) | (%) | (%) | (%) | (%) | (%) | K₂O (%) | Ratio | P |
| 1* | 40.0 | 12.0 | 46.7 | 1.00 | | | 1.00 | 0.00 | 100 |
| 2* | 35.9 | 14.0 | 48.6 | 1.35 | | | 1.35 | 0.00 | 58 |
| 3* | 49.6 | 11.7 | 36.8 | 1.21 | | | 1.21 | 0.00 | 46 |
| 4* | 46.5 | 12.5 | 39.3 | 0.94 | 0.38 | | 1.32 | 0.21 | 80 |
| 5* | 40.2 | 11.8 | 45.9 | 0.77 | 0.79 | | 1.56 | 0.40 | 98 |
| 6 | 45.3 | 12.2 | 40.7 | 0.58 | 0.69 | | 1.27 | 0.44 | 120 |
| 7 | 45.2 | 12.3 | 40.3 | 0.45 | 1.16 | | 1.61 | 0.63 | 143 |
| 8 | 46.7 | 11.9 | 39.5 | 0.19 | 0.68 | 0.45 | 0.87 | 0.70 | 224 |
| 9 | 44.6 | 12.4 | 40.8 | 0.21 | 1.40 | 0.09 | 1.61 | 0.81 | 207 |
| 10 | 50.0 | 11.8 | 36.6 | 0.12 | 1.17 | 0.02 | 1.29 | 0.87 | 252 |

*means “outside the invention”.

It is seen that the P index increases when the Ratio increases. Enriching the products in potassium oxide relative to the amount of sodium oxide so that the Ratio is greater than 0.30 when the Na₂O content is less than 0.60%, or so that the Ratio is greater than 0.60, makes it possible to promote the penetration of waves into the refractory product, and thus to improve the quality of monitoring, without any deterioration in feasibility.

As is clearly seen, the invention thus provides a product which has noteworthy performance in the environment of a glass melting furnace vessel.

Needless to say, the invention is not limited to the embodiments described and shown, which are provided solely for illustrative purposes.

1. A fused cast refractory product comprising, as mass percentages on an oxide basis, and for a total of 100%:

| ZrO₂ + HfO₂: | 39.0% to 55.0%, with HfO₂ <5% |
|---|---|
| SiO₂: | 10.5% to 14.0% |
| Al₂O₃: | remainder to 100% |
| Na₂O + K₂O: | 0.80% to 3.00% |
| B₂O₃: | <1.0% |
| Fe₂O₃ + TiO₂: | <0.60% |
| other species: | <1.0% |

the ratio (K₂O/1.52)/(Na₂O+K₂O/1.52) being greater than 0.30 with Na₂O<0.60%, or
the ratio (K₂O/1.52)/(Na₂O+K₂O/1.52) being greater than 0.60%.

2. The product as claimed in claim 1, in which the ratio (K₂O/1.52)/(Na₂O+K₂O/1.52) is greater than 0.40.

3. The product as claimed in claim 2, in which the ratio (K₂O/1.52)/(Na₂O+K₂O/1.52) is greater than 0.50.

4. The product as claimed in claim 3, in which the ratio (K₂O/1.52)/(Na₂O+K₂O/1.52) is greater than 0.60.

5. The product as claimed in claim 4, in which the ratio (K₂O/1.52)/(Na₂O+K₂O/1.52) is greater than 0.62.

6. The product as claimed in claim 5, in which the ratio (K₂O/1.52)/(Na₂O+K₂O/1.52) is greater than 0.65.

7. The product as claimed in claim 1, in which the ZrO₂+HfO₂ mass content is greater than 42.5%.

8. The product as claimed in claim 7, in which the ZrO₂+HfO₂ mass content is greater than 43.5%.

9. The product as claimed in claim 8, in which the ZrO₂+HfO₂ mass content is greater than 44.5%.

10. The product as claimed in claim 1, in which the ZrO₂+HfO₂ mass content is less than 52.5%.

11. The product as claimed in claim 10, in which the ZrO₂+HfO₂ mass content is less than 51.0%.

12. The product as claimed in claim 11, in which the ZrO₂+HfO₂ mass content is less than 49.5%.

13. The product as claimed in claim 12, in which the ZrO₂+HfO₂ mass content is less than 48.0%.

14. The product as claimed in claim 1, in which the SiO₂ mass content is less than 13.5%.

15. The product as claimed in claim 14, in which the SiO₂ mass content is less than 13.0%.

16. The product as claimed in claim 1, in which the SiO₂ mass content is greater than 11.0%.

17. The product as claimed in claim 1, in which the Na₂O mass content is less than 0.60%.

18. The product as claimed in claim 17, in which the Na₂O mass content is less than 0.55%.

19. The product as claimed in claim 18, in which the Na2O mass content is less than 0.50%.

20. The product as claimed in claim 1, in which, in mass percentages based on the oxides:

| | |
|---|---|
| Na₂O + K₂O: | 0.80% to 2.50%, preferably 0.80% to 2.00% |
| Na₂O: | <0.60%, preferably <0.55% |

with a ratio (K₂O/1.52)/(Na₂O+K₂O/1.52) greater than 0.60.

21. The product as claimed in claim 1, in which the K₂O mass content is greater than 0.60% and less than 2.00%.

22. The product as claimed in claim 1, in which the K₂O mass content is greater than 0.70%.

23. The product as claimed in claim 22, in which the K₂O mass content is greater than 0.80%.

24. The product as claimed in claim 23, in which the K2O mass content is greater than 1.00%.

25. The product as claimed in claim 1, in which the K₂O mass content is less than 1.80%.

26. The product as claimed in claim 1, in which the Na₂O+K₂O mass content is less than 2.50%.

27. The product as claimed in claim 26, in which the Na₂O+K₂O mass content is less than 2.00%.

28. The product as claimed in claim 1, in which the Al₂O₃ mass content is less than 44.0% and greater than 30.0%.

29. A fused cast refractory product comprising, as mass percentages on an oxide basis, and for a total of 100%:

| ZrO₂ + HfO₂: | 39.0% to 51.0%, preferably 39.0% to 49.5%, |
|---|---|
| | preferably 42.5% to 49.5%, |
| SiO₂: | 10.5% to 13.0% |
| Al₂O₃: | remainder to 100%, preferably <44.0% |
| K₂O: | 1.00% to 2.00%, preferably 1.10% to 1.80% |
| Na₂O: | <0.50%, preferably <0.40%, preferably <0.30% |
| B₂O₃: | <1.0% |
| Fe₂O₃ + TiO₂: | <0.60% |
| other species: | <1.0% |

with a ratio (K₂O/1.52)/(Na₂O+K₂O/1.52) greater than 0.65.

30. A glass melting furnace comprising a vessel intended to contain or containing molten glass, the vessel including a block made of a product as claimed in claim 1.

31. A process for monitoring a glass melting furnace, said process including the following steps:
application of an electromagnetic wave to a block of refractory material as claimed in claim 1;
analysis of the signal received in response to said application so as to determine information relating to said block or to a change of medium, notably reflecting an interface.
